(19) United States
(12) Patent Application Publication
(10) Pub. No.: US 2013/0268891 A1
(43) Pub. Date: Oct. 10, 2013

(54) RAPID RESPONSE DECISION DEVICE

(71) Applicants: George Michael Finley, Texarkana, TX (US); Juntao Michael Yuan, Austin, TX (US); Ron Kimberly Johnson, Austin, TX (US)

(72) Inventors: George Michael Finley, Texarkana, TX (US); Juntao Michael Yuan, Austin, TX (US); Ron Kimberly Johnson, Austin, TX (US)

(21) Appl. No.: 13/441,508

(22) Filed: Apr. 6, 2012

(51) Int. Cl. G06F 3/048

(52) U.S. Cl. 715/825

(57) ABSTRACT

Methods and systems that facilitate rapid response to critical changes in a patient's condition. The disclosed techniques and structures may facilitate rapid input of data (e.g., observed conditions) by a nurse or other clinician, and may provide clinical decision support information based on the input data. In some cases, a user interface that dynamically updates a list of possible causes (e.g., medical conditions) in response to each received input may be provided. In some cases, a user interface presents input selection controls in a check list-type format, and allows a nurse to answer all, or only a subset, of the input selections, in any order.

### BACKGROUND

This disclosure relates generally to health care-related information processing, and more specifically to diagnostic systems that may be suited for use by nurses in identifying, assessing, and addressing changes in patient status.

Nurses and other clinicians that provide front-line response to patients in hospitals or other health care settings (e.g., nursing homes) may be required to quickly respond to critical changes in a patient's condition, such as a sudden symptom change or an adverse event. It may be crucial that the nurse accurately evaluate the symptoms, take proper steps to initiate stabilization of the patient's condition, prepare interventions in accordance with an existing care plan, and/or escalate the situation as appropriate (e.g., to Rapid Response Team and/or physician). Furthermore, time may be a critical factor in mitigating damage experienced by the patient. Thus, the nurse's management of a critical change may require accurate decision making in a very short period of time. The challenges associated with this high-stress decision making be complicated by the fact that the critical change may often occur at a time when a nurse may be fatigued, has no opportunity to review the patent's full medical history, and/or may not have an opportunity to communicate with other medical team members. Accordingly, errors in decision making may occur.

Conventional diagnostic decision support software tools include applications directed to assisting physicians and/or patients narrow down potential diagnoses based on observed symptoms. For example, a diagnostic decision support tool may query a user (e.g., a physician) with a set of various symptom-related questions to determine a potential diagnosis based on the set of responses. In some cases, these tools may guide the user by further refining the symptom-related queries as each response is received in order to “drill down” to a diagnosis.

Consumer-facing symptom checkers include applications aimed at assisting consumers (e.g., patients) to understand possible causes of their own symptoms (e.g., prior to seeking treatment for a health care professional, or as a supplement to a health care professional's diagnosis). These applications typically may instruct a user to seek professional medical assistance in cases where medical conditions of concern may be present. These tools may also guide the user by further refining the symptom-related queries as each response is received in order to “drill down” to a diagnosis.

### SUMMARY

Techniques and structures are disclosed that facilitate rapid response to critical changes in a patient's condition. In certain embodiments, the disclosed techniques and structures may facilitate rapid input of data (e.g., observed conditions) by a nurse or other clinician, and may provide clinical decision support information based on the input data. Embodiments may provide a user interface that dynamically updates a list of possible causes (e.g., medical conditions) in response to each received input. Some embodiments may include a user interface that presents input selection controls in a check list-type format, and allows a nurse to answer all, or only a subset, of the input selections, in any order.

In one embodiment, a user interface is displayed at a computer system (e.g., personal computer system, tablet computer, smart phone). The user interface may include a first listing of input conditions (e.g., inputs) and a first listing of possible causes (e.g.; outputs). A first user selection that indicates a first selected condition from the first listing of input conditions may be received by the computer system (e.g., via a user selection made at the touch screen of a tablet). The displayed user interface may be updated by changing the display from the first listing of possible causes to a second listing of possible causes. The updating of the displayed user interface may be a dynamic update, which is preformed in response to receiving the first user selection (e.g., an update performed in response to receiving a single-touch of a first user selection at a touch screen).

In some embodiments, the first and second listings of possible causes may be equal sets of possible causes (e.g., sets having the same elements, regardless of order of the elements). In particular ones of these embodiments, the second listing of possible causes may present members of the equal sets of possible causes in a different order from an order presented in the first listing of possible causes (e.g., the first and second listings may have identical members, but listed in differing orders). In some embodiments, the possible causes may be sorted by an estimated probability of correspondence to the first selected condition.

In some embodiments, the displayed user interface may also be updated to change from the first listing of input conditions to a second listing of input conditions in response to receiving the first user selection. In particular embodiments, the first and second listings of input conditions are equal sets of input conditions. The second listing of input conditions may in some cases present members of the equal sets of input conditions in a different order than an order presented in the first listing of input conditions.

In some embodiments, a second user selection indicating a second selected condition may be received subsequent to the dynamic updating of the displayed user interface to change from the first listing of possible causes to the second listing of possible causes. In some cases, the displayed user interface may be dynamically updated from the second listing of possible causes to a third listing of possible causes in response to receiving the second user selection. The third listing of possible causes may be determined based on the first selected condition and the second selected condition. In some embodiments, one or more additional user selections indicating one or more additional selected conditions may be subsequently received, and in some cases the displayed user interface may be dynamically updated from the third listing of possible causes to a fourth listing of possible causes in response to receiving the additional third user selection. The fourth listing of possible causes may be determined based on the first selected condition, the second selected condition, and the one or more additional selected conditions.

Some embodiments may cause an alert to be issued in response to determining that a probability of a particular possible cause exceeds a threshold value. In various embodiments, the alert may be a page, and email alert, a text message (e.g., via an SMS service), a message sent via an instant messaging service (e.g., a message sent via a chat-type service), etc.

Particular embodiments may display information corresponding to a particular possible cause in response to an indication of a particular possible cause from a listing of possible causes (e.g., in response to a user selection of a listed possible cause, such as the cursor hovering above a listed possible cause). In some cases, the displayed information may include information relating to treatment of the particular possible cause. In some cases, the displayed information may include a listing of recommended additional information to be collected.

### BRIEF DESCRIPTION OF THE DRAWINGS

FIG. 1A depicts various exemplary embodiments of the claimed systems, and various systems that may practice the claimed methods.

FIG. 1B is a block diagram of one embodiment of a system depicted in FIG. 1A.

FIG. 2 is a flowchart illustrating operation of one embodiment of a rapid response decision device.

FIGS. 3A-3C depict various aspects of one user interface that may be used in embodiments of the present rapid response decision device.

FIGS. 4A-4C depict presentation of additional information relating to possible causes, as may be performed by some embodiments of the present disclosure.

FIG. 5 depicts one example of an alert that may be generated according to some embodiments.

### DETAILED DESCRIPTION OF EMBODIMENTS

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### TERMINOLOGY

The following paragraphs provide definitions and/or context for terms found in this disclosure (including the appended claims):

“Dynamically Updating . . . . In Response To.” This term refers to performing a “update” task, where performance of the update task is initiated “in response to” some event. Thus, “dynamically updating X in response to Y” indicates that the task of updating X is performed upon the event Y.

Consider the example terminology “dynamically updating the display to show A, wherein said dynamically updating is performed in response to receiving selection B.” A scenario where the display is updated (e.g., modified, refreshed) to show A due to selection B (e.g., upon receipt of an indication of a user selection of B at a touch screen) corresponds to the example terminology. However, a scenario where the display is updated to show A only after receiving both selection B and also a subsequent selection C does not correspond to the example terminology.

“Equal Sets.” This term refers to two or more sets that contain the same elements, regardless of the order of the elements. For example, sets {A, B, C, D} and {B, A, D, C} are equal sets. Sets {A, B, C} and {A, B, C} are also equal sets. Sets {A, B, C} and {A, B, C, D} are not equal sets.

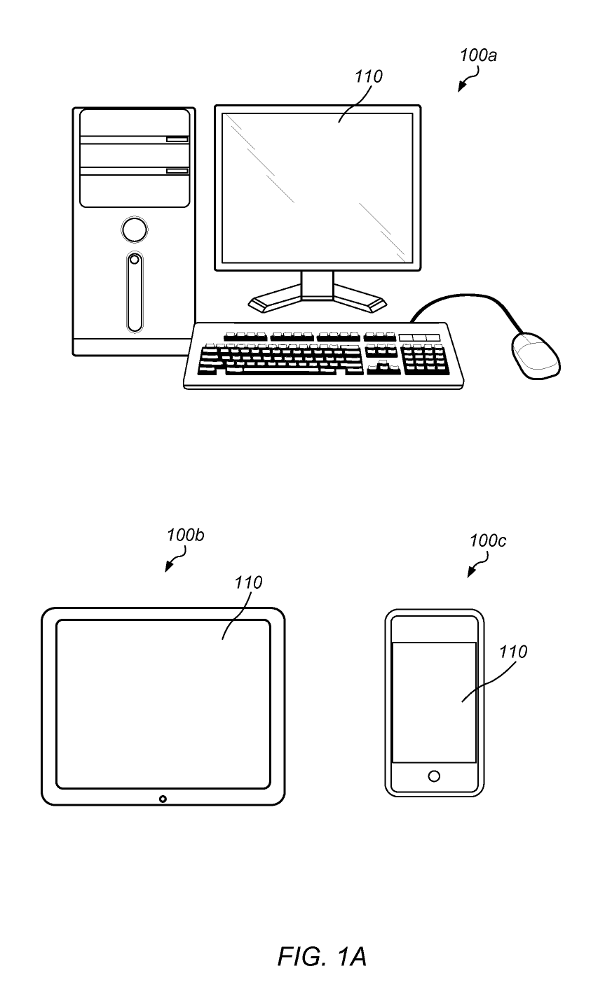

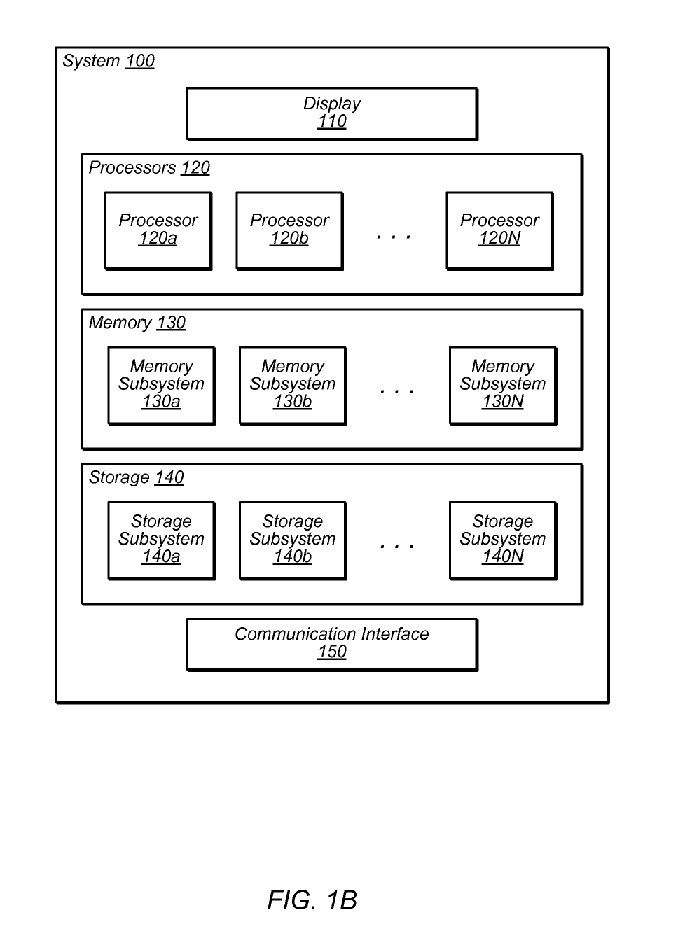

“Computer System.” This term has its ordinary and accepted meaning in the art, and includes one or more computing devices operating together and any software stored thereon. A computing device includes one or more processor units and a memory subsystem. A memory subsystem may store program instructions executable by the one or more processor units. An exemplary computer system is described in more detail with reference to FIG. 1A.

“Usable By.” In the context of “element X is ‘usable by’ computer system Y to do Z,” this phrase refers to a situation in which computer system Y is configured to perform function Z using (e.g., reading, manipulating, executing) element X. Thus, if a computer system is configured to generate an output set of data by performing various operations, including determining members of the output set of data based on a received input, it can be said that the received input is “usable by” the computer system to determine the members of the output set of data.

“First,” “Second,” etc. As used herein, these terms are used as labels for nouns that they precede, and do not imply any type of ordering (e.g., spatial, temporal, logical, etc.) unless otherwise indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Comprising” This term is open-ended. As used in the appended claims, this term does not foreclose additional structure or steps. Consider a claim that recites: “A system, comprising one or more processors . . . .” Such a claim does not foreclose the apparatus from including additional components (e.g., a network interface, storage subsystem). “Including” and “having” are similarly used terms that are also open-ended.

“Configured To.” As used herein, this term means that a particular piece of hardware or software is arranged to perform a particular task or tasks when operated. Thus, a computer system that is “configured to” perform task A means that the computer system includes a circuit, program instructions stored in memory, or other structure that, during operation of the computer system, performs or can be used to perform task A. (As such, a computer system can be “configured to” perform task A even if the computer system is not currently on.) Similarly, a computer program that is “configured to” perform task B includes instructions, that if executed by a computer system, perform task B.

“Coupled.” As used herein, this term means that various elements are connected, although not necessarily directly, and not necessarily mechanically. For example, consider computer system A wirelessly communicating with computer system B via an intermediate device. Computer system A can be said to be coupled to computer system B (and vice versa).

### Hardware Systems

Various exemplary embodiments of the present systems are depicted in FIG. 1A. Computer system 100 may assist a nurse to quickly and appropriately react to a critical change in the condition of a patient (e.g., in a hospital or nursing home). For example, front-line response to a critical change in a patient, such as a sudden symptom change or adverse event, may require nursing staff to quickly and accurately evaluate symptoms in order to initiate proper steps to stabilize the patient. Also, nurses may need to prepare interventions that comply with an existing care plan for the patient, and to escalate the situation if appropriate (e.g., to a Rapid Response Team or physician). Thus, a nurse may need to perform multiple cognitive tasks and make multiple critical decisions in a short period of time in order to provide a patient the best chance for a positive outcome.

Computer system 100 may be any type of computer system suitable for use by nurses or other clinicians to process patient-related information. Some embodiments of computer system 100 may store program instructions that are executable by computer system 100 to cause the computer system to perform methods of the present disclosure. Various embodiments of computer system 100 may be configured to read instructions that are stored on computer-readable media (e.g., hard disks, compact discs, DVDs, flash memory, tape), where the instructions are executable by computer system 100 to cause the computer system to perform methods of the present disclosure.

As one example, computer system 100a may be a personal computer that is located in a hospital room, such as a dedicated personal computer that is cabinet-mounted near a patient's bed. In some embodiments, computer system 100a may be a fixedly mounted personal computer that is alternately located, such as in a hospital or nursing home hallway, or at a nursing station. Other embodiments may include a mobile cart-mounted personal computer (e.g., a laptop computer), or an non-mounted mobile computer than may be hand carried by a nurse. Computer system 100a may include display 110, which may in some embodiments be a touch screen allowing a user to provide input to computer system 100a using, for example, a fingertip or stylus. Other embodiments may employ a mouse, trackball, and/or other pointing device for facilitating user input in addition to, or instead of a touch screen. Various embodiments may also or alternately include a keyboard, voice recognition system, and/or other means for facilitating user input.

As another example, computer system 100b may be a tablet computer system. In some embodiments, computer system 100b may be a mobile system that is configured to be carried by a nurse, thereby providing a portable method for processing data at a patient's bedside. Such a mobile system may employ wireless communication protocols (e.g., wireless local area networks, cellular data networks, personal area networks) to facilitate mobile data transfer. Such mobile systems may be particularly cost effective in some cases, as it may be possible to support a number of patient rooms using fewer computer systems (e.g., one tablet computer system per on-duty nurse, as opposed to one fixed personal computer per patient room). A smart phone or personal digital assistant embodiment computer system 100c may provide similar portability. Embodiments of computer system 100b and computer system 100c may include display 110 that includes a touch screen.

Turning now to FIG. 1B, a block diagram of one embodiment of computer system 100 is depicted. As shown, computer system 100 includes display 110, processors 120, memory 130, storage 140, and communication interface 150. Communication interface 150 may be coupled to one or more networks, such as wireless local area networks, cellular data networks, personal area networks, wired local area networks, and/or other communication networks that may, for example, facilitate communication of data (e.g., electronic medical record or other data relevant to patient treatment) between computer system 100 and one or more information systems.

In some embodiments of the present disclosure, communication with various other computer systems and information systems may enable a nurse to use computer system 100 to coordinate with essential resources located in a hospital, nursing home, or elsewhere to improve the total response time, and to provide improved decision support accuracy. For example, consider a scenario in which a patient experiences sudden symptom changes. Based on observed patient conditions that are input by the nurse, computer system 100 may be used to calculate probabilities of possible medical causes corresponding to the observed patient conditions. Speed and/or accuracy of this data input and calculation may be improved in some embodiments by utilizing a patent's existing electronic medical records (EMR) data, which may be received by computer system 100 from, for example, one or more information systems (e.g., databases at the hospital, databases at other hospitals or other health care provider networks). Computer system 100 may display various possible causes of the condition change in a list that is ordered based on the calculated probability of the respective possible causes. In this example, computer system 100 may calculate a significant probability that the cause the patient's change of condition is a heart attack. In some embodiments, an alert (e.g., page, text message, email, chat message) may automatically be set to appropriate parties, such as a rapid response team and/or physician, by computer system 100 in cases where the calculated probability that the cause is a heart attack satisfies one or more conditions (e.g., calculated probability of a heart attack exceeds a threshold value). Thus, valuable time-to-respond may be saved through the automatic generation of alerts and the leveraging of existing patient EMR data. The leveraging of existing EMR data may also improve the accuracy of the calculated probabilities of the various possible causes.

Continuing with FIG. 1B, processors 120 may include one or more processors. For example, processors 120 may be a multi-processor configuration that includes processors 120a, 120b, etc. Embodiments of processors 120 may include one or more processor components that may individually include multiple processor cores. In some embodiments, processors 120 includes one or more coprocessor units. Processors 120 (or each processor within 120) may contain a cache or other form of on-board memory. In general, computer system 100 is not limited to any particular type of processor unit or processor subsystem.

Memory 130 may include one or more memory subsystem components. For example, in various embodiments memory 130 may be implemented using one or more subsystems that may individually include flash memory, random access memory (RAM-SRAM, EDO RAM, SDRAM, DDR SDRAM, RDRAM, etc.), ROM (PROM, EEPROM, etc.), and/or various other forms of volatile or non-volatile memory. Memory 130 may store program instructions executable by computer system 100 using processors 120, including program instruction executable to cause computer system 100 to implement the various techniques disclosed herein.

Storage 140 may include one or one or more storage subsystem components. For example, in various embodiments storage 140 may be implemented using one or more subsystems having any type of physical storage technology, including hard disk storage (e.g., magnetic or solid state), floppy disk storage, optical disk storage, tape storage, and so on. Some embodiments of computer system 100 may not include storage 140 that is separate from memory 130 (e.g., systems having only volatile memory, systems having non-volatile memory implemented in flash memory only). In some embodiments, all or part of storage 140 may be remote from the other components of computer system 100. Storage 140 may in some cases include a virtual storage subsystem, accessed, for example, though a cloud computing provider. Storage 140 may store program instructions executable by computer system 100 using processors 120, including program instruction executable to cause computer system 100 to implement the various techniques disclosed herein.

As noted above, display 110 may in some embodiments be a touch screen allowing a user to provide input to computer system 100 using, for example, a fingertip or stylus. Other embodiments may include display 110 that is not a touch screen, but is instead a conventional display (e.g., an LCD monitor, CRT monitor, or any other type of display that is suitable for use with a computer system). Some embodiments of computer system 100 may employ multiple components (e.g., two or more LCD monitors) that may collectively provide display 110.

### User Interface

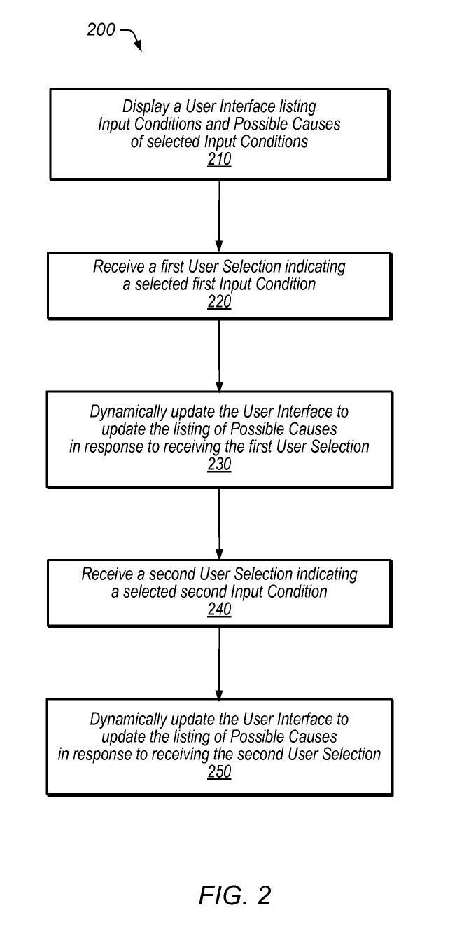

Turning now to FIG. 2, a flowchart of method 200 that may be performed by one embodiment of computer system 100 is depicted. Method 200 may in various cases be performed by a computer system having form factors including, for example: a tablet computer system, a notebook computer system, a desktop computer system, a smart phone, a personal digital assistant, or other form factors that may be suitable for use by nurses or other clinician in a hospital, or other care-providing environment.

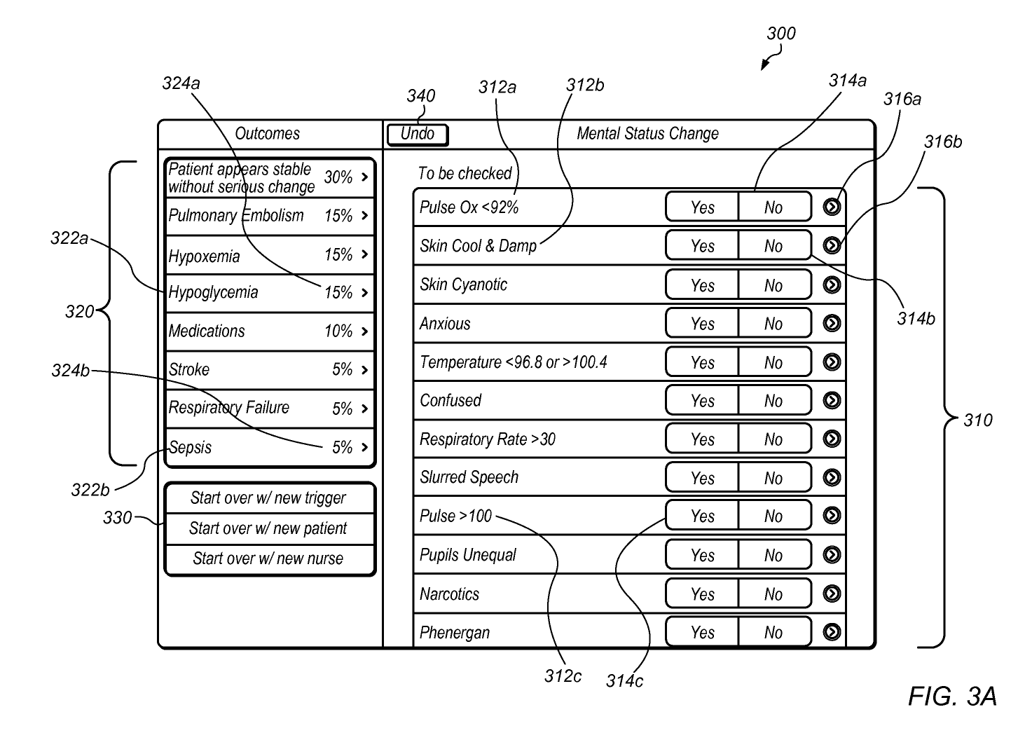

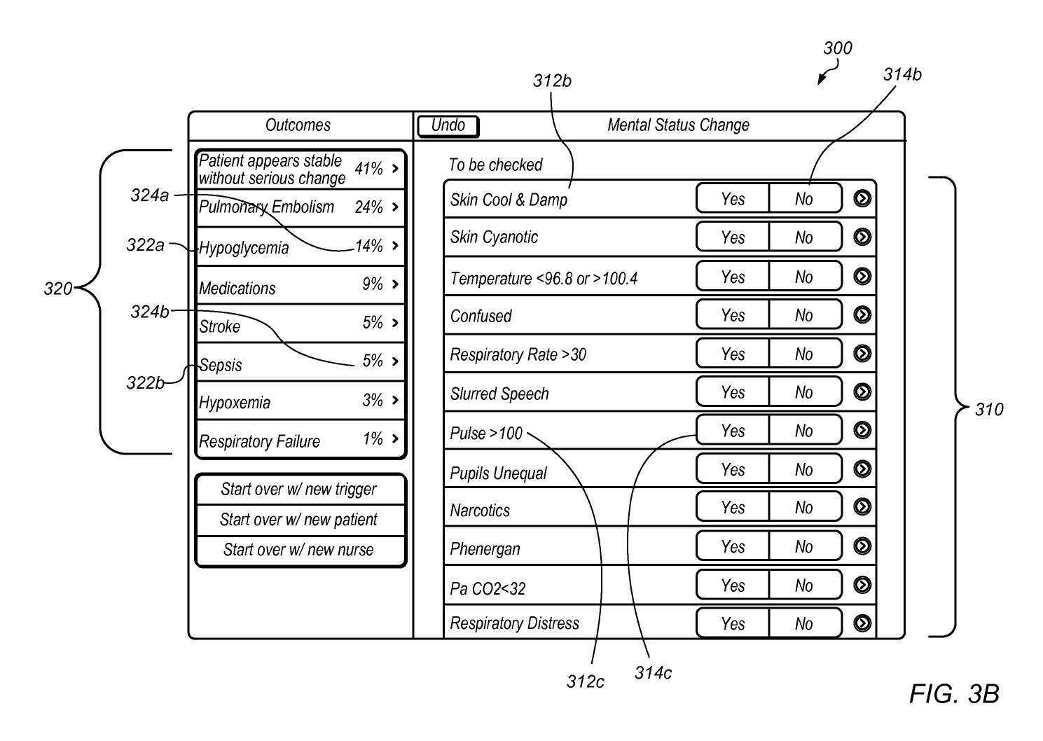

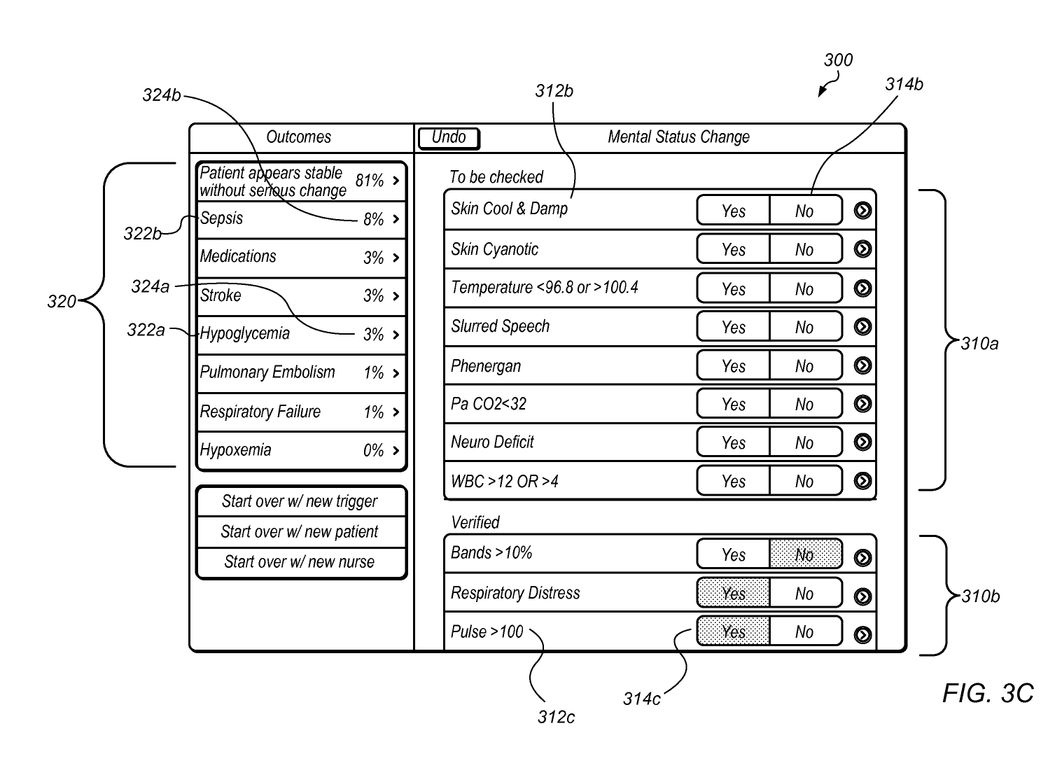

In item 210, a user interface may be displayed by the computer system. Turning also to FIG. 3A, an exemplary embodiment of user interface 300 is depicted. User interface 300 may include input portion 310 and output portion 320. Input portion 310 may present the user with a list of input conditions (e.g., observed symptoms) that may be selectable by the user in order to record observed conditions in the patient. Output portion 320 may present the user with a list of possible causes (e.g., medical conditions) relating input conditions selected by the user.

In various embodiments, user interface 300 may provide the user with a quick and intuitive manner in which to efficiently enter data, as compared to conventional systems. For example, consider conventional systems that may be aimed towards assisting a doctor or a patient assess symptoms. Such conventional systems typically may include a user interface that prompts a user to enter symptoms or other data in a guided manner. For example, conventional systems may require a user to answer questions in a specific (e.g., guided) order. In some conventional systems, a subsequent question for presentation to the user may be based on the user's answer to a previous question. While such conventional systems may in some cases be useful for assisting formulation of a doctor's diagnosis of a patient's condition (or a patient's self-diagnosis), this methodology may not be well suited to the challenges faced by a front-line responder that is faced with a patient undergoing a critical change in status.

The font-line responder may be faced with numerous challenges that may contribute to errors in properly assessing a patient's condition and to errors in identifying appropriate responses in a timely manner. For example, fatigue, cognitive bias, and an overloaded (e.g., distraction-filled) work environment may contribute to non-optimal nursing decisions, which may in some cases lead to a failure to rescue a patient.

User interface 300 may provide a nurse or other front-line care provider with an arrangement that is better suited to providing accurate decision support in a hospital or other care-providing environment. For example, the listing of input conditions 312 may be presented in a “check list” type format that provides the user with an intuitive, easy-to-scan list from which observed symptoms may be entered. Input of conditions may be accomplished through simple yes/no input controls (e.g., controls 314) that in various embodiments may be selected in a non-guided manner.

As an illustration of the non-guided manner of input that is facilitated by particular embodiments of the present disclosure, consider input portion 310 in FIG. 3A. In this depicted example, control 314c allows for a user to input a “yes” or “no” designation for the input condition “Pulse>100” (item 312c). Input conditions 312a (“Pulse Ox<92%”) and 312b (“Skin Cool & Damp”) are presented as preceding (above) input condition 312c the listing in input portion 310. However, the order of the listing does not require the user to select the controls corresponding to the input conditions in any particular order. Instead, the user may choose to select the input conditions in any order that is expedient and convenient in light of the situation. Thus, a nurse that is taking action in response to observing that a patient's pulse has unexpectedly risen to over 100 beats per minute may choose to immediately select “yes” in control 314c without first making a selection for any of the other input conditions that precede the “Pulse>100” input condition in the listing of input portion 310. This unguided manner of input may be much more efficient in critical situations when reacting to a sudden change in condition, as the information that is readily at hand may be entered without requiring the nurse to first address other check list items (e.g., measuring oxygen saturation level).

Furthermore, as discussed below, possible causes may be determined based on the selected input conditions, without requiring the user to make a selection corresponding to every input condition listed in input portion 310. Thus, input of critical patient data may be accomplished in a less-constrained manner that may allow more rapidly arriving at an accurate diagnosis.

Referring again to FIG. 2, a present system may receive a user selection indicating a selected input condition (item 210). Such a selection may be made by the user via user interface 300, as discussed above. In various embodiments, selection may be made via a touch screen interface (e.g., using a single touch, multiple touches, gestures, or other indications made using a finger, stylus, or other instrument). In various other embodiments, selection may be made via a different form of pointing device (e.g., mouse, trackball, touchpad). In some embodiments, selection may be made via keyboard entry, and/or via voice recognition.

In some embodiments, a particular input condition may be removed from the listing in input portion 310 after the user has made a selection corresponding to that particular input condition. In some of these embodiments, a listing of previously “answered” input conditions (input conditions for which information has been selected) may be provided in a separate list. FIG. 3C depicts an example of an embodiment in which previously answered input conditions are removed from unanswered input sub-portion 310a, and instead listed in answered input sub-portion 310b. These embodiments may allow a user to change previous selections by, for example, re-entering a selection for controls 314 in answered input sub-portion 310b (e.g., control 314c in FIG. 3C).

Various embodiments of user interface 300 may reorder the listing of the input conditions presented in input portion 310 after a user has made a selection corresponding to a particular input condition. For example, in some cases the particular input condition may be moved to the bottom of the listing of input conditions. In some cases, other members of the listing of input conditions may be reordered based on the selection of the particular input condition. For example, non-selected input conditions may be reordered such that likely-related or likely-relevant input conditions (e.g., to the particular input condition, to the aggregate of all previously-selected input conditions) are moved to the top of the listing of input conditions. In some embodiments, the listing of input conditions may contain the same members (but possibly in different order) after selection of the particular input condition as before selection (equal sets before and after selection of the particular input condition).

In some embodiments, additional controls (e.g., 316a, 316b, 316c) may be selected by the user to access additional information related to each input condition (e.g., protocols for assessing presence of the input condition; patient-specific history related to the input condition; notes that were previously-entered by the user, or by other nurses). Some embodiment may include controls (e.g., controls 330 and 340) that may assist a user in navigation, such as navigating between records or “undoing” entries to return to a previous state.

Referring again to FIG. 2, item 230 includes dynamically updating the displayed user interface, in response to receiving the user. The dynamic updating may update the user interface to change from a first listing of possible causes to a second listing of possible causes (e.g., changing the order of the listed possible causes and/or adding/removing members of the listing of possible causes). This “dynamic updating” refers to performing the changing from the first listing of possible causes to the second listing of possible causes upon receipt of the user selection (e.g., upon a single-touch selection corresponding to a particular input condition, upon a mouse click corresponding to a particular input condition). Thus, dynamic updating in response to receiving each user selection of an input condition results in the listing of possible causes to be updated upon each user selection of an input condition.

In contrast to the above-described dynamic updating in response to receiving each user selection, convention methods that employ a guided manner of data entry may prompt a user to answer a plurality of questions (e.g., a web page containing multiple questions) and to subsequently submit the plurality answers as a batch (e.g., using a “submit” button that corresponds to all of the plurality of questions on the web page) in order prompt an update. Such conventional methods do not dynamically update in response to receiving each selection, as an update is performed only after the batch submission of multiple user selections, and not as a result of each user selection.

Turning again to FIG. 3A, some embodiments include user interface 300 that may provide output to the user in a manner that is well suited to the needs of a nurse performing front-line support. For example, output portion 320 may provide a listing of possible causes 322 (e.g., medical conditions) in response to a user's selection (e.g., using controls 314) relating to one or more input conditions 312. The listing of possible causes may include several possible causes that may be ordered in a useful manner. For example, some embodiments may include output portion 320 listing a predetermined number of possible causes that are determined to be the most probable, based on the combination of input condition information that has been entered by the user. This list may be ordered based determined probability. Other output portion 320 may list all possible causes that are above a determined threshold probability. Some embodiments may list a fixed set of possible causes, sorted by probability. In some cases, the listing of possible causes may be sorted based on severity/urgency (e.g., conditions requiring quick intervention may be listed first). In some embodiments, the listing may be a combination of the above-discussed examples, and/or other orderings.

In various embodiments, output portion 320 may be dynamically updated to re-sort the listing of possible causes based on each of several subsequently received user entries of input condition (items 240 and 250 of FIG. 2). For example, FIGS. 3A-3C may depict possible conditions 322a (Hypoglycemia) and 322b (Sepsis) listed within output portion 320 in a sequence of varying positions, sorted based on a sequence of received user indications of input conditions 312 (made using controls 314). Continuing with the example, FIG. 3A may depict a listing of possible causes that is sorted based on probabilities determined from a first input conditions entered by a user. In some embodiments, the determined probabilities 324 may be displayed in output portion 320. FIG. 3B depicts a possible updated listing of possible causes 322, dynamically updated in response to a second input condition entered by the user. The updated listing may be based on determined probabilities that are calculated using the first and the second input conditions. FIG. 3C depicts a possible further updated listing of possible causes 322, dynamically updated this time in response to receipt of a subsequent third input condition entered by the user. The further updated listing may be based on determined probabilities that are calculated using the first, second, and third input conditions.

In some embodiments, dynamically updating the listing of possible causes may result in an updated listing containing the same members (but possibly in different order) after updating (equal sets before and after updating). In other embodiments, the dynamic updating may results in the updated listing containing different members from prior to the updating.

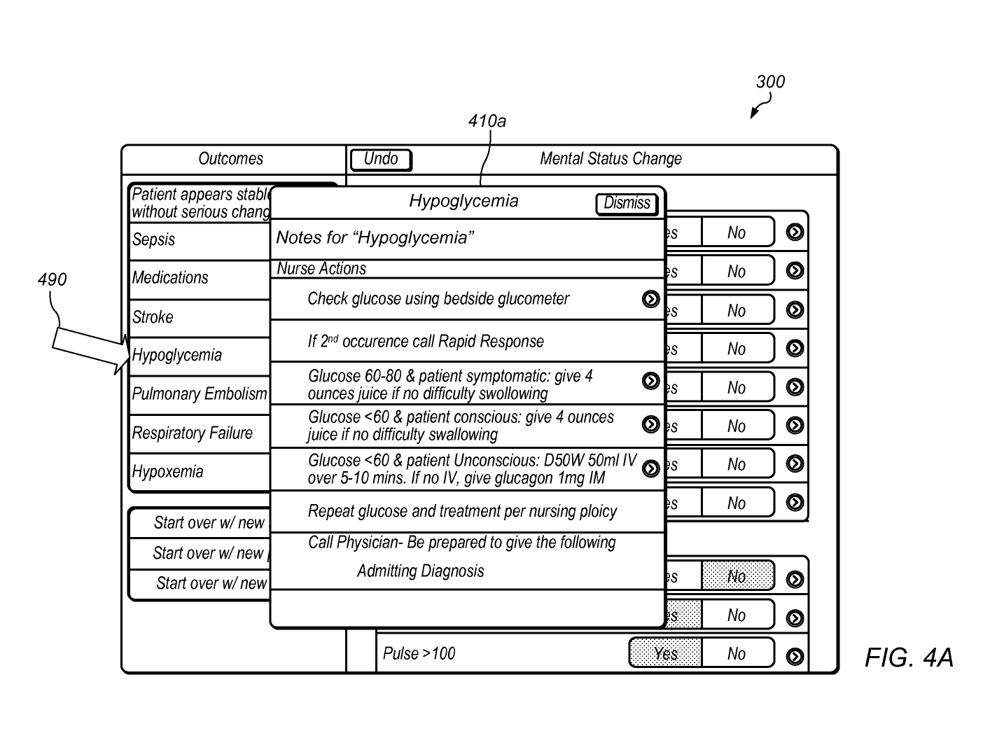

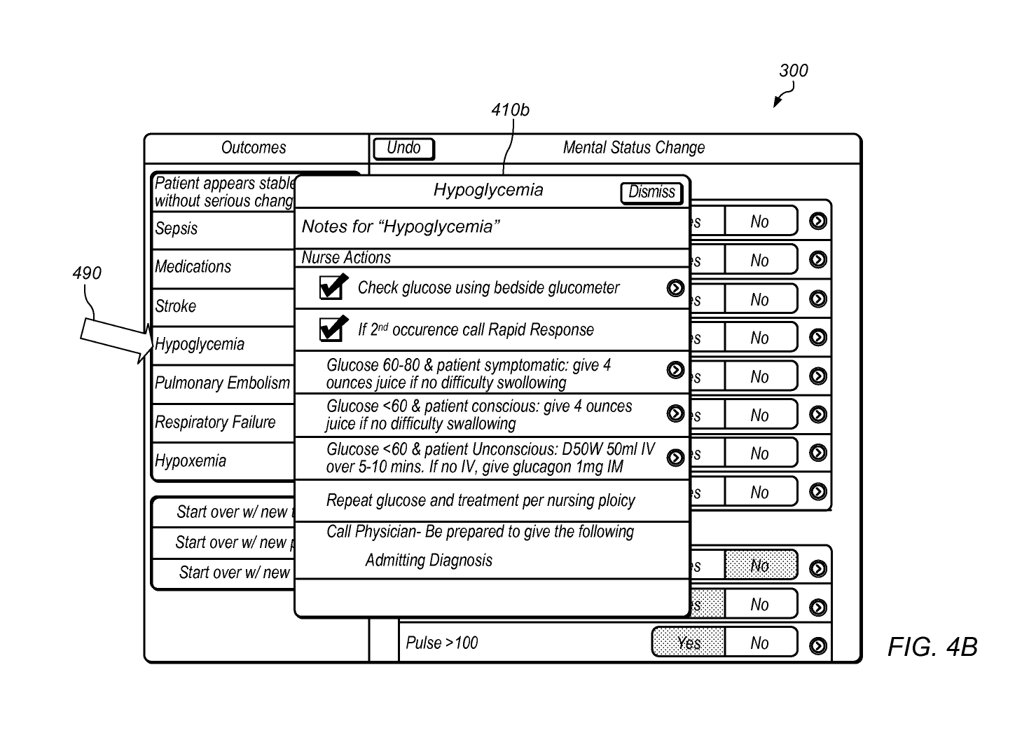

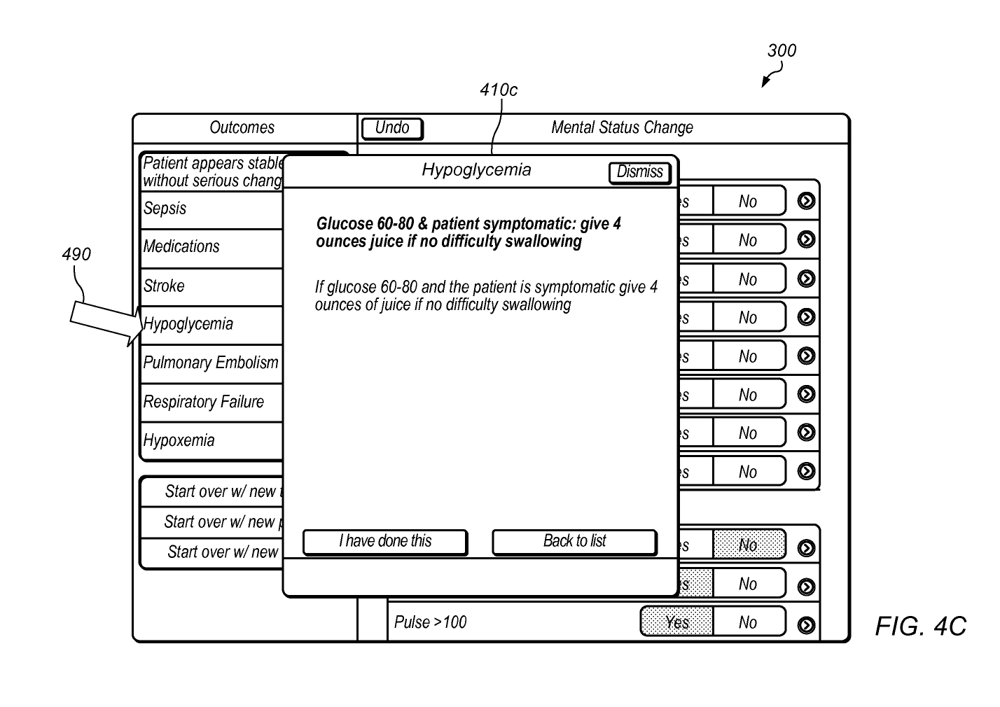

Some embodiments of the present disclosure include user interface 300 that may provide information relating the medical conditions represented possible causes. For example, FIGS. 4A-4C depict examples in which user indication 490 of “Hypoglycemia” may result in the display of additional information (410a, 410b, 410c) that may include, for example, recommended actions for the nurse to take to address the medical condition represented by the possible cause, instructions to escalate to a physician, recommended information to be collected and provide to the physician, checklists, and protocols relating to the medical condition). Such information may in some cases also include and/or be based on, for example, data related to the patient's treatment records and to current hospital orders/procedures. In some cases, the present systems may access this data from a remote location (e.g., hospital database) via communication interface 150. User indication 490 may, in various embodiments, be a result of a user selection action (e.g., touch at a touchpad, mouse click) or a result of pointer placement (e.g., cursor or pointer hover location).

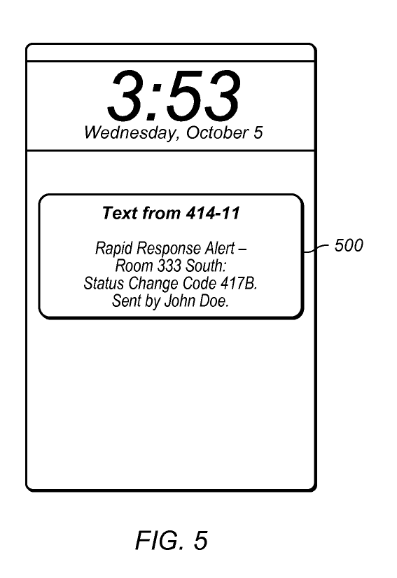

Various embodiments may be configured to automatically initiate escalation (e.g., to a rapid response team, supervisory nurse, physician) in particular cases. For example, a page, email alert, text message, or other appropriate alert may be issued (e.g., via communication interface 150) in cases where a probability of a particular possible cause (e.g., a severe medical condition) meets a certain condition (e.g., exceeds a threshold probability value). The conditions for escalation may be based on, and adjusted (e.g., via communication interface 150), in accordance 0 with current hospital orders and procedures. FIG. 5 depicts an example of an escalation alert 500 sent via text message to a rapid response team.

Articles of manufacture that store instructions (and, optionally, data) executable by a computer system to implement various techniques disclosed herein are also contemplated. These articles of manufacture include tangible computer-readable memory media. The contemplated tangible computer-readable memory media include portions of a memory subsystem of server 110 (without limitation SDRAM, DDR SDRAM, RDRAM, SRAM, flash memory, and various types of ROM, etc.), as well as storage media or memory media such as magnetic (e.g., disk) or optical media (e.g., CD, DVD, and related technologies, etc.). The tangible computer-readable memory media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
displaying a user interface at a computer system, wherein the user interface includes a first listing of input conditions and a first listing of possible causes;
receiving a first user selection indicating a first selected condition from the first listing of input conditions;
dynamically updating the displayed user interface to change from the first listing of possible causes to a second listing of possible causes, wherein said dynamically updating is performed in response to said receiving the first user selection.

2. The method of claim 1,
wherein said receiving the first user selection includes receiving a single touch at a touch screen;
wherein said dynamically updating the displayed user interface is performed in response to said receiving the single touch at the touch screen; and
wherein the first and second listings of possible causes are equal sets of possible causes, and wherein elements of the second listing of possible causes are presented in a different order than an order of elements presented in the first listing of possible causes.

3. The method of claim 2, wherein the different order presented in the second listing of possible causes includes the possible causes sorted by estimated probability of correspondence to the first selected condition.

4. The method of claim 2,
wherein said dynamically updating the displayed user interface to change to the second listing of possible causes comprises presenting an indication of probabilities associated with one or more individual possible causes in the second listing of possible causes.

5. The method of claim 1, further comprising:
updating the displayed user interface to change from the first listing of input conditions to a second listing of input conditions;
wherein the first and second listings of input conditions are equal sets of input conditions, and wherein elements of the second listing of input conditions are presented in a different order than an order of elements presented in the first listing of input conditions.

6. The method of claim 1, further comprising:
subsequent to said dynamically updating the displayed user interface to change from the first listing of possible causes to the second listing of possible causes, receiving a second user selection indicating a second selected condition;
in response to said receiving the second user selection, dynamically updating the displayed user interface from the second listing of possible causes to a third listing of possible causes, wherein the third listing of possible causes is determined based on the first selected condition and the second selected condition.

7. The method of claim 6, further comprising:
subsequent to said dynamically updating the displayed user interface to change from the second listing of possible causes to the third listing of possible causes, receiving one or more additional user selections indicating one or more additional selected conditions;
in response to said receiving the one or more additional user selections, dynamically updating the displayed user interface to change from the third listing of possible causes to a fourth listing of possible causes, wherein the fourth listing of possible causes is determined based on the first selected condition, the second selected condition, and the one or more additional selected conditions.

8. The method of claim 1, further comprising:
causing an alert to be issued in response to determining that a probability of a particular possible cause exceeds a threshold value.

9. The method of claim 1, further comprising:
responsive to an indication of a particular possible cause from the second listing of possible causes, displaying information corresponding to the particular possible cause.

10. An article of manufacture including a computer-readable medium having instructions stored thereon that, in response to execution by a computing device, cause the computing device to perform operations, comprising:
displaying a user interface including a first listing of input conditions and a first listing of possible causes;
receiving a first user selection indicating a first condition from the first listing of input conditions;
in response to said receiving the first user selection, dynamically updating the user interface by changing from the first listing of possible causes to a second listing of possible causes, wherein at least two members of the second listing of possible causes are members of the first listing of possible causes, and wherein the at least two members are presented in a different order in the second listing of possible causes than in the first listing of possible causes.

11. The article of manufacture of claim 10, wherein the second listing of possible causes includes the members of the first list of possible causes sorted by estimated probability of correspondence to the first condition.

12. The article of manufacture of claim 10,
wherein the dynamically updating the user interface further includes changing from the first listing of input conditions to a second listing of input conditions;
wherein the first and second listings of input conditions are equal sets of input conditions; and
wherein the second listing of input conditions includes elements sorted in a different order than an order presented in the first listing of input conditions

13. The article of manufacture of claim 10, wherein the operations further comprise:
in response to a selection relating to a particular possible cause from the second listing of possible causes, displaying information corresponding to the particular possible cause.

14. The article of manufacture of claim 13, wherein the displayed information corresponding to the particular possible cause includes information relating to treatment of the particular possible cause.

15. The article of manufacture of claim 13, wherein the displayed information corresponding to the possible cause includes a listing of recommended additional information to be collected.

16. A computing device, comprising:
a display;
one or more processors; and
memory coupled to the one or more processors, the memory having stored thereon instructions that, in response to execution by the computing device, cause the computing device to perform operations including:
rendering a user interface at the display, wherein the user interface includes a first listing of input conditions and a first listing of possible causes;
in response to receiving a first user selection indicating a first condition from the first listing of input conditions, dynamically updating the output portion by changing from the first listing of possible causes to a second listing of possible causes.

17. The computing device of claim 16,
wherein the first and second listings of possible causes are equal sets of possible causes, and wherein elements of the second listing of possible causes are presented in a different order than an order of elements presented in the first listing of possible causes

18. The computing device of claim 16,
wherein the display comprises a touch screen; and
wherein the receiving the first user selection includes receiving a single touch at the touch screen; and
wherein the dynamically updating rendered user interface is performed in response to the receiving the single touch at the touch screen.

19. The computing device of claim 16,
wherein the receiving the first user selection includes receiving a mouse selection; and
wherein the dynamically updating the rendered user interface is performed in response to the receiving the mouse selection.

20. The computing device of claim 16, further comprising:
a communication interface;
wherein the operations further comprise sending an alert via the communication interface in response to determining that a probability of a particular possible cause exceeds a threshold value.
